(19) United States
(12) Patent Application Publication
(10) Pub. No.: US 2026/0339971 A1
(43) Pub. Date: Oct. 29, 2026

(54) IMPORTING DIGITAL MEDIA CONTENT FROM EXTERNAL DEVICES UTILIZING CONTEXT AWARE QR CODES

(71) Applicant: Adobe Inc., San Jose, CA (US)

(72) Inventors: Vipin Gupta, Delhi (IN); Parvesh Singla, Gurgaon Sector 45 (IN); Nishant Kumar, Greater Noida (IN); Navneet Mehta, Faridabad (IN)

(21) Appl. No.: 19/187,801

(22) Filed: Apr. 23, 2025

(51) Int. Cl. G06F 16/25; G06K 7/14

(52) U.S. Cl. CPC G06F 16/25; G06K 7/1417

(57) ABSTRACT

The present disclosure relates to systems, non-transitory computer-readable media, and methods for embedding data of digital content items within a digital design editing workflow via a context-aware QR code. For example, the disclosed systems extract, in response to scanning a QR code, QR code information including context parameters of a digital design editing workflow at a second device as defined by a unique context identifier within the QR code. In some embodiments, the disclosed systems provide the QR code information including the context parameters of the digital design editing workflow to a client application of the first device. The disclosed systems present a set of digital content items within the client application by filtering digital content items according to the context parameters of the digital design editing workflow. In various embodiments, the disclosed systems upload selected digital content items to a temporary storage location corresponding to the QR code.

### BACKGROUND

The creation and editing of digital content often involves the use of elements from multiple sources, such as cloud-based storage or external devices (e.g., mobile devices). For example, many content editing workflows involve importing or sharing files, images, documents, and other digital content types across various digital platforms for creating diverse digital media content for use in many different contexts. Ensuring that elements in digital designs or other digital documents are aesthetically and thematically consistent is an important aspect of digital content creation. Furthermore, improvements in data transfer technologies have led to an increase in the number of ways in which content editing workflows allow for the combination of elements from different sources into digital content. However, current content editing workflows offer limited, inefficient tools for importing media into a workflow.

### SUMMARY

One or more embodiments described herein provide benefits and/or solve one or more of the foregoing or other problems in the art with systems, methods, and non-transitory computer-readable media that embed digital content items retrieved from an external device into a digital design editing workflow by generating a context-aware QR-code. To illustrate, in one or more embodiments, the disclosed systems, via a context-aware QR code, filters digital content on an external device according to context parameters of a digital design editing workflow and embeds selected digital content within the digital design editing workflow. In some embodiments, the disclosed systems also include techniques for generating a QR code with a unique context identifier according to one or more context parameters of a digital design editing workflow of a client application. In one or more embodiments, the disclosed systems further introduce processes for selecting digital content items of a client device by resolving parameters received via the QR code and passing the resolved filters to an application of the external device. In some cases, the disclosed systems detect the selected digital content items transferred to a temporary storage location by utilizing metadata files associated with the transfer. In various embodiments, the disclosed systems additionally embed data of the selected digital content items into the digital design editing workflow.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures.

FIG. 1 illustrates a diagram of an environment in which a contextual QR system operates in accordance with one or more embodiments.

FIG. 2 illustrates an overview diagram of the contextual QR system integrating a digital content item from an external device into a digital design editing workflow in accordance with one or more embodiments.

FIG. 3 illustrates a diagram of the contextual QR system generating a context-aware QR code in accordance with one or more embodiments.

FIG. 4 illustrates a diagram of the contextual QR system filtering content on an external device based on contextual parameters from a scanned QR code in accordance with one or more embodiments.

FIG. 5 illustrates a diagram of the contextual QR system transferring selected digital content items in accordance with one or more embodiments.

FIG. 6 illustrates a diagram of the contextual QR system embedding digital content item data into a digital design editing workflow in accordance with one or more embodiments.

FIGS. 7A-7B illustrate sequence diagrams of the contextual QR system in accordance with one or more embodiments.

FIGS. 8A-8E illustrate example graphical user interfaces for importing digital content into a digital design editing workflow using a context-aware QR code in accordance with one or more embodiments.

FIG. 9 illustrates a schematic diagram of the contextual QR system in accordance with one or more embodiments.

FIG. 10 illustrates a flowchart of a series of acts for uploading selected digital content items by extracting QR code information including context parameters in accordance with one or more embodiments.

FIG. 11 illustrates a flowchart of a series of acts for receiving a set of digital content items by generating a QR code including context parameters in accordance with one or more embodiments.

FIG. 12 illustrates a block diagram of an example computing device for implementing one or more embodiments of the present disclosure.

### DETAILED DESCRIPTION

This disclosure describes one or more embodiments of a contextual QR system that manages the embedding of digital content items from an external device by generating a context-aware QR code according to one or more parameters of a digital design editing workflow. Specifically, in some embodiments, the contextual QR system extracts context parameters from a digital design editing workflow in response to a request to retrieve digital content from an external device and generates a context-aware QR code including the context parameters of the digital design editing workflow. In response to an external device (e.g., a mobile device) scanning the context-aware QR code, in some cases, the contextual QR system provides a set of digital content items for selection by filtering digital content items stored on the external device according to the context parameters encoded within the QR code. In one or more cases, the contextual QR system also imports/transfers selected digital content items (and corresponding metadata files) from the external device into the digital design editing workflow according to the context parameters. The contextual QR system thus provides intelligent incorporation of relevant external digital content items into the digital design editing workflow.

As just mentioned, in some embodiments, contextual QR system generates a context-aware QR code by extracting one or more context parameters from a digital design editing workflow at a computing device. In some cases, the contextual QR system generates a context-aware QR code that includes a URL to a unique temporary storage location and one or more extracted context parameters. For example, the contextual QR system extracts, from the digital design editing workflow, a content use parameter indicating an interaction of a digital content item within the digital design editing workflow, a content type parameter indicating a nature of a digital content item to be utilized within the digital design editing workflow, or an application architecture parameter indicating characteristics of the client application relative to a digital design editing workflow.

In some embodiments, in response to scanning the context-aware QR code, the contextual QR system provides a set of digital content items for selection by filtering digital content items stored on an external device according to context parameters encoded in the context-aware QR code. In various cases, the contextual QR system resolves the context parameters received in the context-aware QR code and passes the resolved context parameters as filter parameters to a corresponding application on the external device. For example, the contextual QR system passes a filter parameter indicating a particular location to a photos application and causes the photos application to return digital photographs including depictions of that location for selection.

In one or more embodiments, the contextual QR system transfers selected digital content items to the initial computing device. For example, the contextual QR system uploads one or more selected digital content items to a temporary storage location embedded in the context-aware QR code. In some cases, to inform the digital design editing workflow of the availability of selected digital content items, the contextual QR system additionally uploads, with the selected items, a first metadata file corresponding to the start of uploading selected digital content items and a second metadata file corresponding to the end of uploading selected digital content items. Further, in certain embodiments, the contextual QR system informs the external device of the status of the upload of the selected digital content items.

In various cases, the contextual QR system utilizes the transferred digital content items as directed by contextual parameters of the digital design editing workflow. In these or other embodiments, the contextual QR system inserts the selected digital content item(s) into a digital design of the digital design editing workflow according to contextual parameters of the workflow. In additional embodiments, the contextual QR system opens the selected digital content item(s) as one or more separate instances within the client application at the computing device.

As suggested above, many conventional systems exhibit a number of shortcomings or disadvantages, particularly in efficiently embedding external digital content items into a digital design editing workflow. To elaborate, some existing systems utilize QR codes to initiate transfers of digital content from one device to another. These existing systems are limited to initiating a transfer process (e.g., launching a client application at a mobile device) and are incapable of leveraging contextual information associated with a digital design editing workflow to facilitate the transfer. Accordingly, such systems require additional user interactions to find and upload digital content that is relevant to the digital design editing workflow. For example, if a user wants to upload a particular file type from a specific folder, the user must find the folder on their device and select the type of file the user is looking for within the specific folder. Not only do the user interactions to search for specific desired content require additional user input to search for the desired content, but such processing also increases the computational cost and waiting time required by the system to upload the selected digital content items. Furthermore, many users are not familiar with the file structures on their external devices, making it difficult for them to navigate data structures and identify relevant items.

Due at least in part to their inefficiencies, many prior systems are also inaccurate. Some current systems, while capable of transferring various types of digital content from an external device, are incapable of recognizing certain formats of digital content that are compatible with existing digital design editing workflows. Upon a user selecting a specific digital content item that the system is incapable of uploading, some systems either fail to recognize the content entirely, or attempt to upload the desired content and fail due to such incompatibilities.

Additionally, some prior systems provide ambiguous feedback to users during file transfer processes, leaving users uncertain as to the status of their file transfers. Furthermore, various conventional systems facilitate selection of irrelevant content for utilization within a digital design editing workflow. For example, a user may select to upload an entire folder of digital content items when intending to utilize only a limited number of content items within the digital design editing workflow. As these systems rely on users to find and select content to transfer, the digital content items that are ultimately uploaded are often not utilized within the digital design editing workflow, resulting in inaccurate or irrelevant uploads that unnecessarily utilize computing resources to transfer and process on the source and destination devices.

In addition to problems of inefficiency and inaccuracy, conventional QR-based upload systems also experience problems of operational inflexibility. For example, certain conventional systems have limited customization and workflow adaptation. Specifically, current QR-based upload systems generate simple QR codes that upload selected content to a storage location while lacking tools to customize data associated with the transfer (e.g., file destinations or access controls). Thus, in current QR-based upload systems, users are forced to use a specific upload format without the option to change settings according to the corresponding workflow-thus rendering current systems insufficient or ineffective in various use cases.

As suggested, one or more embodiments of the contextual QR system improve conventional systems. For example, in one or more embodiments, the contextual QR system improves computational efficiency and speed over current systems. For instance, by generating a QR code with metadata corresponding to context parameters of a digital design editing workflow, the contextual QR system presents a limited relevant number of digital content items to a user to select. In some cases, by filtering selectable digital content items according to context parameters of a digital design editing workflow, the contextual QR system reduces user interactions with external devices to select relevant digital content items for integration into the digital design editing workflow. Indeed, in contrast to conventional QR-based systems that merely initiate a rigid process to access content on an external device, context-aware filtering through QR-code metadata reduces the time spent by a user finding relevant content by finding the most relevant content on an external device without requiring the user, in some embodiments, to select the relevant application on the external device and navigate potentially large amounts of content items. Additionally, as the contextual QR system, in various cases, determines a maximum number of relevant content items to upload based on the contextual information from a digital design editing workflow, the expenditure of computational resources is likewise limited, thus improving efficiency over conventional systems.

Relatedly, as mentioned, embodiments of the contextual QR system improve accuracies of prior systems, particularly in regard to uploading selected digital content items by generating a QR-code. As discussed previously, in some embodiments, the contextual QR system generates a QR code including QR information representing one or more context parameters of a digital design editing workflow. Specifically, in response to a scan of the QR code, the contextual QR system decodes context parameters of the digital design editing workflow embedded in the QR code and passes them to an external device to filter content on the external device and provide a set of digital content items according to the context parameters. As the contextual QR system, in various embodiments, filters available digital content items according to context parameters of a digital design editing workflow, the contextual QR system streamlines relevant content selection, assisting users in finding accurate content that otherwise would not be discovered.

Additionally, in one or more cases, the contextual QR system automatically extracts context parameters of a digital design editing workflow, removing opportunities for user inaccuracies in selecting digital content relevant to the workflow. For example, the contextual QR system detects one or more of a content use parameter indicating an interaction of a digital content item within the digital design editing workflow, a content type parameter indicating a nature of a digital content item to be utilized within the digital design editing workflow, or an application architecture parameter indicating a structure of the client application relative to a digital design editing workflow without required user input. In various cases, by utilizing the extracted contextual parameters, the contextual QR system provides relevant digital content items to a user for selection, streamlining the process of selecting digital content relevant to, and functionally compatible with, a digital design editing workflow.

Similarly, embodiments of the contextual QR system improve operational flexibility of computing systems for editing digital designs. In some embodiments, the contextual QR system, by extracting context parameters from the digital design editing workflow, allows for flexible relevant digital content item determination. For example, the contextual QR system detects (or extracts) a variety of context parameters relating to how digital content items within the workflow will be used, the type of digital content items to be used, and/or architectural parameters relating to the client application utilized in the workflow. Additionally, in these or other embodiments, the contextual QR system allows a user to select desired contextual parameters to facilitate the selection of relevant digital content. The variety of context parameters available to be embedded in a unique QR code improve the flexibility of the contextual QR system over conventional systems. Thus, the entire pipeline provides flexibility in how users upload and utilize digital content items within a digital design editing workflow.

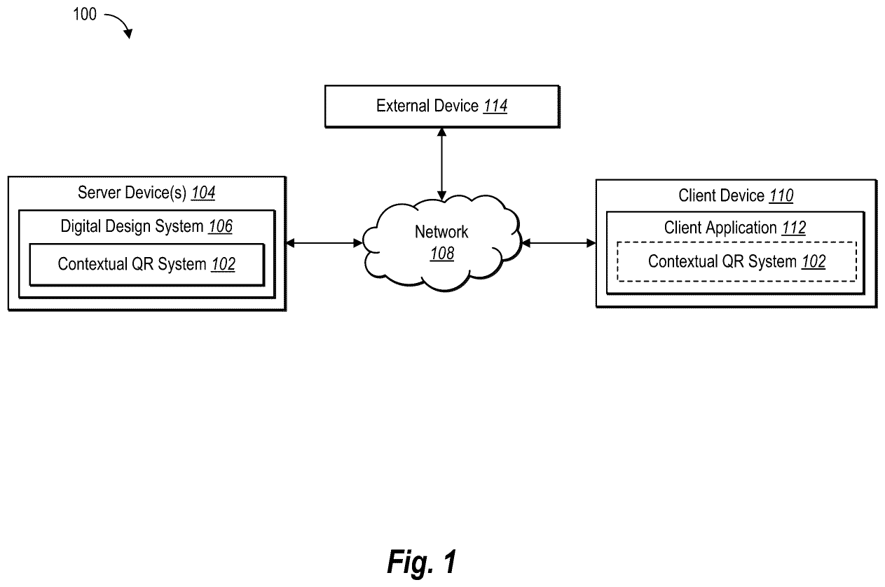

Additional detail regarding the contextual QR system will now be provided with reference to the figures. For example, FIG. 1 illustrates a schematic diagram of an example system environment 100 for implementing a contextual QR system 102 in accordance with one or more embodiments. An overview of the contextual QR system 102 is described in relation to FIG. 1. Thereafter, a more detailed description of the components and processes of the contextual QR system 102 is provided in relation to the subsequent figures.

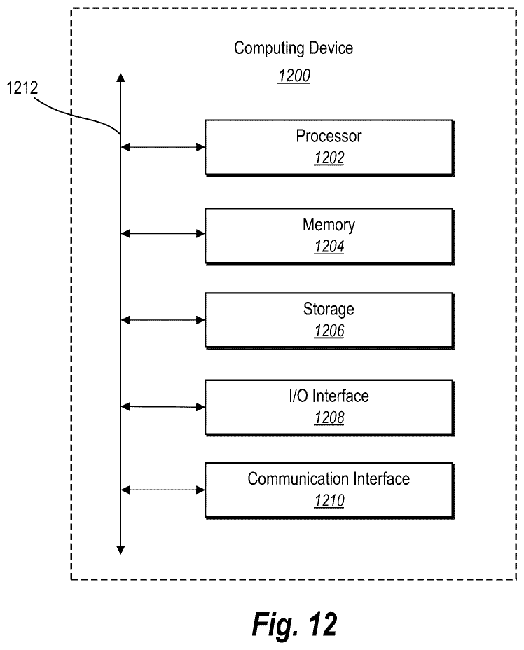

As shown, the system environment 100 includes server device(s) 104, a client device 110, and a network 108. Each of the components of the system environment 100 communicate via the network 108, and the network 108 is any suitable network over which computing devices communicate. Example networks are discussed in more detail below in relation to FIG. 12.

As mentioned, the system environment 100 includes a client device 110. The client device 110 is one of a variety of computing devices, including a smartphone, a tablet, a smart television, a desktop computer, a laptop computer, a virtual reality device, an augmented reality device, or another computing device as described in relation to FIG. 12. Although FIG. 1 illustrates a single instance of the client device 110, in some embodiments, the system environment 100 includes multiple different client devices, each associated with a different user. The client device 110 communicates with the server device(s) 104 and/or the digital design system 106 via network 108. For example, the client device 110 receives information from the server device(s) 104 and provides information to server device(s) 104 relating to contextual parameters of a digital design editing workflow.

As shown in FIG. 1, the client device 110 includes a client application 112. In particular, the client application 112 is a web application, a native application installed on the client device 110 (e.g., a mobile application or a desktop application), or a cloud-based application where all or part of the functionality is performed by the server device(s) 104. The client application 112 presents or displays information to a user, including a graphical user interface for inputting a user input requesting retrieval of digital content from an external device.

As also illustrated in FIG. 1, the system environment 100 includes the server device(s) 104. The server device(s) 104 generates, tracks, stores, processes, receives, and transmits electronic data, such as text related to one or more contextual parameters of the digital design editing workflow. For example, the server device(s) 104 receives data from the client device 110 in the form of user input requesting retrieval of digital content from an external device 114 via a graphical user interface. In response, the server device(s) 104 provides data to the client device 110 in the form of one or more selected digital content items, as described herein.

In some embodiments, the server device(s) 104 communicates with the client device 110 to transmit and/or receive data via the network 108. In some embodiments, the server device(s) 104 comprises a distributed server where the server device(s) 104 includes a number of server devices distributed across the network 108 and located in different physical locations. The server device(s) 104 comprise a content server, an application server, a communication server, a web-hosting server, a multidimensional server, or a machine learning server.

As further shown in FIG. 1, the server device(s) 104 also includes the contextual QR system 102 as part of a digital design system 106. For example, in one or more implementations, the digital design system 106 stores, generates, modifies, edits, enhances, provides, distributes, and/or shares digital content, such as user-selected digital content items from an external device 114 (e.g., a mobile device storing digital images). For example, the digital design system 106 provides a graphical user interface for user input including a request to access digital content from the external device 114 via the use of a QR code involving one or more contextual parameters of a digital design editing workflow. Specifically, the digital design system 106 uses the accessed digital content from the external device 114 for insertion or inclusion in the digital design editing workflow.

In one or more embodiments, the server device(s) 104 includes all, or a portion of, the contextual QR system 102. For example, the contextual QR system 102 operates on the server device(s) 104 to embed data of one or more selected digital content items relevant to a contextual parameter of a digital design editing workflow. In some embodiments, the client device 110 includes all or part of the contextual QR system 102. For example, the client device 110 generates, obtains (e.g., downloads), or uses one or more aspects of the contextual QR system 102. Indeed, in some implementations, as illustrated in FIG. 1, the contextual QR system 102 is located in whole or in part of the client device 110 (e.g., as part of the client application 112). For example, the contextual QR system 102 includes a web hosting application that allows the client device 110 to interact with the server device(s) 104. To illustrate, in one or more implementations, the client device 110 accesses a web page supported and/or hosted by the server device(s) 104.

Although FIG. 1 illustrates a particular arrangement of the system environment 100, in some embodiments, the system environment 100 has a different arrangement of components and/or may have a different number or set of components altogether. For instance, as mentioned, the contextual QR system 102 is implemented by (e.g., located entirely or in part on) the client device 110. In addition, in one or more embodiments, the client device 110 communicates directly with the contextual QR system 102, bypassing the network 108.

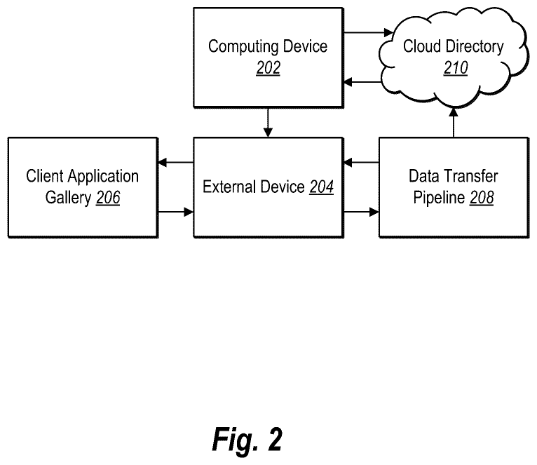

As mentioned above, in certain embodiments, the contextual QR system 102 performs operations for embedding digital content item data into a digital design editing workflow according to one or more contextual parameters of the workflow. In particular, the contextual QR system 102 embeds digital content item data retrieved from an external device 114 into a digital design editing workflow according to one or more contextual parameters of the workflow via the use of a context-based QR code. FIG. 2 illustrates an overview diagram of the contextual QR system integrating a digital content item from an external device into a digital design editing workflow in accordance with one or more embodiments. Additional detail regarding the various acts and processes introduced in relation to FIG. 2 is provided thereafter with reference to subsequent figures.

As illustrated in FIG. 2, in some cases, the contextual QR system 102 extracts (or detects) one or more contextual parameters of a digital design editing workflow present on a computing device 202. In one or more embodiments, the contextual QR system 102 extracts one or more contextual parameters such as a content use parameter indicating an interaction with a digital content item within the digital design editing workflow, a content type parameter indicating a file type of a digital content item to be utilized within the digital design editing workflow, or an application architecture parameter indicating attributes of the client application relative to a digital design editing workflow. In these or other embodiments, the contextual QR system 102 determines the contextual parameters based on input by a user in addition to (or instead of) the contextual QR system 102 automatically extracting contextual parameters of the digital design editing workflow.

In one or more embodiments, a digital design editing workflow refers to or includes a structured process of generating or modifying visual digital content within a graphical user interface. For example, a digital design editing workflow includes operations for generating or editing a digital image or a digital design including image content or multimodal content. To illustrate, the digital design editing workflow includes one or more operations executed by tools for generating/editing digital content, one or more digital canvases, one or more digital design applications, and/or existing digital content in the digital canvas(es) in connection with generating or editing the digital content.

In various embodiments, the contextual QR system 102 generates a context-aware QR code based on the one or more extracted contextual parameters. In one or more cases, the contextual QR system 102 embeds the extracted contextual parameters within a context-aware QR code by utilizing a unique contextID associated with the extracted contextual parameters. In various cases, the contextual QR system 102 additionally (or alternatively) generates a temporary storage location (e.g., the cloud directory 210). In one or more embodiments, the contextual QR system 102 generates a context-aware QR code by embedding the one or more contextual parameters of the digital design editing workflow of the computing device 202 and a short-lived URL (e.g., expiring within a time threshold) that corresponds to the cloud directory 210. In various embodiments, a contextual parameter refers to a variable or setting that reflects the surrounding conditions of a digital design editing workflow and/or intended uses of digital content items within the digital design editing workflow. For example, types of contextual parameters include content type parameters, content use parameters, and/or application architecture parameters, which relate to the context of digital content being edited and the environment in which the digital content is being edited.

As further illustrated in FIG. 2, the contextual QR system 102, via an external device 204, accesses the context-aware QR code. In some embodiments, by scanning the QR code with a camera application of the external device 204, contextual QR system 102 decodes the one or more contextual parameters embedded within the context-aware QR code. In one or more cases, the contextual QR system 102 passes the decoded contextual parameters to a client application of the external device 204. In some embodiments, a context-aware QR code refers to or includes a QR code with contextual parameter metadata embedded within the code, specifically adapting the behavior/content of the QR code based on the context of the digital design editing workflow for which the contextual QR system 102 generated the QR code.

As shown in FIG. 2, in some embodiments, the contextual QR system 102 filters digital content items within a client application on an external device 204 (e.g., a client application gallery 206) to provide a user a subset of digital content items to select from for use in the digital design editing workflow. In particular, in various embodiments, the contextual QR system 102 filters digital content items of a client application gallery 206 according to the extracted contextual parameters of the digital design editing workflow and as decoded from the context-aware QR code. For example, where the contextual QR system 102 detects that the digital design editing workflow relates to a particular location (e.g., Dubai), the contextual QR system 102 filters digital content items of the client application gallery 206 to display digital content items relating to that particular location (e.g., pictures of Dubai and/or pictures taken in Dubai).

In various cases, the contextual QR system 102, upon filtering the client application gallery 206, provides a subset of digital content items for selection (e.g., to embed within the digital design editing workflow of computing device 202) within a graphical user interface of the external device 204. As illustrated in FIG. 2, the contextual QR system 102 transfers digital content items selected by a user from the client application gallery 206 to cause the external device 204 to upload to the data transfer pipeline 208. In one or more embodiments, the contextual QR system 102, via the data transfer pipeline 208, uploads the digital content data to a temporary storage location (e.g., cloud directory 210), as defined by the context-aware QR code.

In one or more embodiments, the contextual QR system 102, through computing device 202, polls the cloud directory 210 to detect the availability of uploaded digital content items for embedding (or displaying) within the digital design editing workflow. In some cases, the contextual QR system 102, upon detecting available digital content items within the cloud directory 210, embeds the data of the one or more digital content items into the digital design editing workflow as determined by the contextual parameters of the workflow. For example, the contextual QR system 102 embeds digital images uploaded by the external device 204 into a digital canvas associated with the digital design editing workflow according to the contextual parameters.

Additionally, in some cases, the contextual QR system 102 uploads metadata files indicating the initialization of the upload process and the termination of the upload process. In various embodiments, the metadata files inform the computing device 202 (and/or the external device 204) of the status of the upload process of the one or more selected digital content items from the client application gallery 206. Specifically, in some cases, the contextual QR system 102 uploads an initialization metadata file before uploading the selected digital content items and uploads a termination metadata file after uploading the selected digital content items. By uploading initialization and termination metadata files, in various cases, the contextual QR system 102 informs the computing device 202 (and/or the external device 204) of the completeness of the upload, as performed via the data transfer pipeline 208.

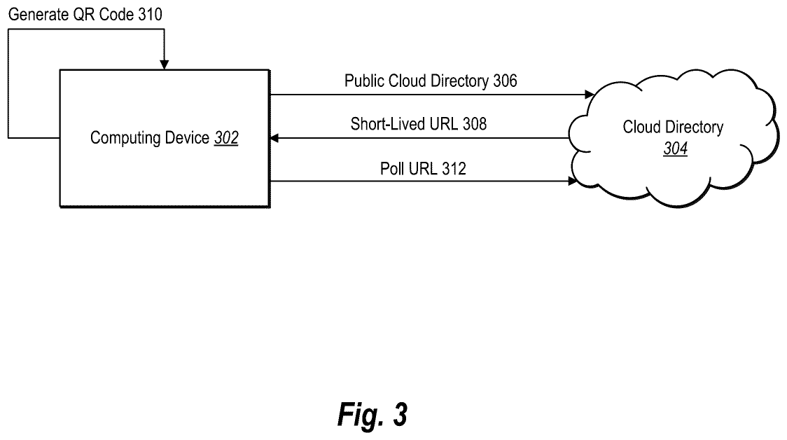

As mentioned above, in certain described embodiments, the contextual QR system 102 generates a context-aware QR code according to contextual parameters of a digital design editing workflow. In particular, in some cases, the contextual QR system 102 generates a context-aware QR code by embedding a location of a temporary storage location in conjunction with the contextual parameters in the context-aware QR code. FIG. 3 illustrates a diagram of the contextual QR system 102 generating a context-aware QR code in accordance with one or more embodiments.

As illustrated in FIG. 3, the contextual QR system 102 utilizes a computing device 302 to generate a temporary storage location (e.g., cloud directory 304). In particular, in some embodiments, the contextual QR system 102 generates (or creates) a public cloud directory 306. In various cases, the cloud directory 304 is a temporary storage location for uploading and/or storing one or more digital content items. Upon creating a public cloud directory 306, the contextual QR system 102 returns a URL 308 to the computing device 302, indicating the location of the cloud directory 304. For example, the contextual QR system 102 generates a URL 308 as a unique identifier that provides access to the cloud directory 304. In some cases, the contextual QR system 102 generates a URL that is a short-lived URL. In these or other embodiments, the contextual QR system 102 generates a URL that is mapped to a public cloud directory used to perform upload requests.

As further illustrated in FIG. 3, the contextual QR system 102 utilizes the short-lived URL 308 to generate a context-aware QR code 310. Specifically, in some cases, the contextual QR system 102 embeds the unique short-lived URL 308 into the context-aware QR code 310. Additionally, in various embodiments, the contextual QR system 102 embeds one or more context parameters into the context-aware QR code 310 with the short-lived URL 308. For example, the contextual QR system 102 generates a unique contextID that corresponds to one or more extracted contextual parameters from a digital design editing workflow and the short-lived URL that indicates the location of the cloud directory 304. Moreover, in some embodiments, the contextual QR system 102 encodes the contextID into a universal link (e.g., a final URL). In various embodiments, the contextual QR system 102 encodes the final URL such that the final URL is equipped to handle special characters. In these or other embodiments, the contextual QR system 102 generates a context-aware QR code for the Final URL, such as by using a JavaScript library to generate the context-aware QR code.

In some embodiments, the contextual QR system 102 extracts one or more content use parameters. Specifically, in various cases, a content use parameter refers to a parameter indicating an interaction with a digital content item within the digital design editing workflow. For example, a content use parameter includes an action relating to the use of an external digital content item. In one or more embodiments, a content use parameter includes an action to be performed such as download, upload, and/or share relating to an external digital content item to be embedded within the digital design editing workflow. In various cases, a content use parameter relating to an action indicates the transfer protocol of the digital content item (or action to be performed relating to the digital content item).

In various embodiments, the contextual QR system 102 extracts (or detects) a content use parameter relating to the type of action being performed within the digital design editing workflow (e.g., source). Specifically, in some cases, the contextual QR system 102 extracts a content use parameter that indicates whether an uploaded digital content item is to be opened on the computing device 302 or placed within the graphical user interface of the digital design editing workflow. In these or other embodiments, the contextual QR system 102 extracts a content use parameter relating to the subtype of a digital content item to be uploaded. For example, the contextual QR system 102 determines a subtype content use parameter indicating a unique identifier to perform a desired task. Specifically, in some embodiments, the contextual QR system 102 determines where to place an uploaded digital content item within the digital design editing workflow. For instance, the contextual QR system 102 determines a photo bin asset ID (and/or a layer ID) for an uploaded digital content item within a digital design editing workflow.

In one or more cases, the contextual QR system 102 extracts (or determines) a content type parameter indicating a file type of digital content items to be used within the digital design editing workflow. In some cases, the contextual QR system 102 determines a content type parameter indicating a nature of a digital content item to be utilized within the digital design editing workflow. For example, the contextual QR system 102 determines the mimetype of the digital content item (asset) such as image/jpg or image/png. In some embodiments, the contextual QR system 102 determines a content type parameter indicating a category of digital content items. For instance, the contextual QR system 102 determines whether digital content items to be uploaded are captured creations (e.g., photographs, videos) and/or generated creations.

In these or other embodiments, the contextual QR system 102 determines a content type parameter indicating a filter used to identify specific digital content items on an external device. For example, the contextual QR system 102 determines a content type parameter indicating a particular location, a particular faceID, or a particular tag embedded within the metadata of digital content items stored on an external device. Furthermore, in various embodiments, the contextual QR system 102 determines a media count indicating the number of digital content items (media) allowed to be selected for embedding within the digital design editing workflow. In some cases, the contextual QR system 102 determines the media count based on available locations for embedding digital content items within the digital design editing workflow.

In one or more cases, the contextual QR system 102 extracts an application architecture context parameter from the digital design editing workflow. In various embodiments, the contextual QR system 102 extracts application architecture parameters indicating attributes of the client application and/or environment of a digital design editing workflow. In some cases, the contextual QR system 102 extracts application architecture parameters indicative of the platform (or product platform) the digital design editing workflow is operating on. For example, the contextual QR system 102 detects an application architecture parameter reflecting whether the digital design editing workflow is performed through a web browser or a desktop application.

In various embodiments, the contextual QR system 102 extracts an application architecture parameter indicating the version of the platform the digital design editing workflow is operating on. Additionally, the contextual QR system 102, in some cases, extracts an application architecture parameter reflecting the environment of the digital design editing workflow. For example, the contextual QR system 102 detects the particular product, stage, and/or development status of the digital design editing workflow (e.g., of the digital design application the digital design editing workflow is operating on).

In some embodiments, the contextual QR system 102 generates a unique contextID encompassing one or more of the contextual parameters extracted from the digital design editing workflow. The contextual QR system 102, in various cases, stores the contextID in a database or associated with the digital design editing workflow to link the context information to the digital design editing workflow. In one or more embodiments, a client application performing the digital design editing workflow has access to the database including the contextID and details associated with the digital design editing workflow, such as digital content items and/or other project data.

Additionally, in one or more embodiments, the contextual QR system 102 generates a context-aware QR code 310 with the contextID encompassing the temporary storage location (e.g., cloud directory 304) and the one or more extracted contextual parameters. In various cases, the contextual QR system 102 generates a context-aware QR code 310 in response to receiving a request for importing (or accessing) external digital content items within a digital design editing workflow. In some embodiments, in response to receiving an additional request for importing (or accessing) external digital content items, the contextual QR system 102 updates the QR code and associated contextual parameters (and contextID) to reflect updated contextual parameters associated with the additional request.

As shown in FIG. 3, in some embodiments, upon generating the context-aware QR code 310, the contextual QR system 102 begins polling the location indicated by the URL 312 to determine the availability of digital media content within the cloud directory 304. In various cases, the computing device 302 polls the location indicated by the URL 312 to determine the availability of digital content items to embed within the computing device. As described in more detail below, in response to detecting that the cloud directory 304 has digital content items, the contextual QR system 102 begins operations to extract digital content items from the cloud directory 304.

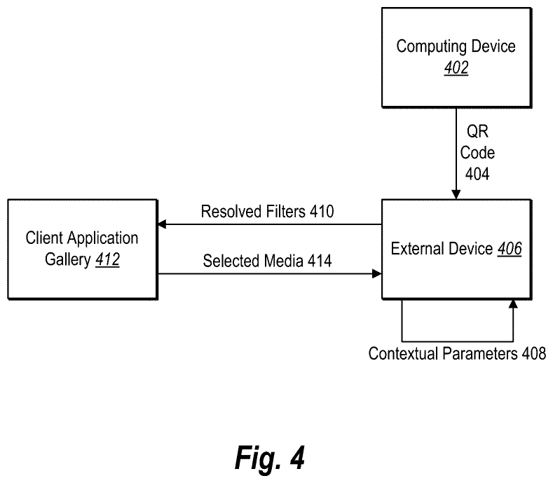

As noted above, in certain described embodiments, the contextual QR system 102 filters digital content items on an external device. In particular, the contextual QR system 102, by scanning a context-aware QR code, filters digital content on an external device according to contextual parameters encoded within the context-aware QR code. FIG. 4 illustrates a diagram of the contextual QR system filtering content on an external device based on contextual parameters from a scanned QR code in accordance with one or more embodiments.

As illustrated in FIG. 4, the contextual QR system 102 scans a context-aware QR code 404 as generated by a computing device 402. In particular, the contextual QR system 102, via an external device 406, scans a context-aware QR code, as discussed previously in relation to FIG. 2. In various cases, the contextual QR system 102, via a camera application of the external device 406, scans the context-aware QR code 404.

A s further illustrated in FIG. 4, in various embodiments, the contextual QR system 102 resolves the contextual parameters 408 of the QR code as scanned by the external device 406. In some cases, the contextual QR system 102 accesses the contextID embedded within the QR code to resolve the contextual parameters 408 of the digital design editing workflow. In one or more embodiments, the contextual QR system 102 passes the resolved parameters, along with the other QR code information, to a client application on the external device 406 as determined by the QR code and/or resolved parameters.

As shown in FIG. 4, the contextual QR system 102 passes resolved filters 410 as determined by resolving the parameters of the QR code. In particular, in various cases, the contextual QR system 102 takes action based on the resolved parameters. For example, the contextual QR system 102, based on a resolved parameter of the QR code, automatically launches (e.g., by causing the external device 406 to launch) a client application on the external device. In some cases, the client application is registered to handle accessing a URL (such as one embedded in the QR code) and thus the contextual QR system 102 automatically launches the URL, thus opening an associated client application. In various embodiments, the client application is registered to handle Universal Links such as standard HTTP or HTTPS links. For example, upon scanning the context-aware QR code 404, the external device opens the URL and checks a file stored on the web server to verify that the website allows the client application to open URLs on behalf of the external device 406.

In some embodiments, the contextual QR system 102 first sends the QR code information to the client application without resolving the parameters of the QR code. In these or other cases, the contextual QR system 102 resolves the parameters via the client application and/or the contextID. Additionally (or alternatively), the contextual QR system 102 determines the URL indicating a location of the temporary storage location (e.g., a cloud public directory URL). In some cases, the contextual QR system 102 accesses the temporary storage location for uploading digital content items from the client application.

As shown in FIG. 4, the contextual QR system 102 filters digital content items of a client application to provide a client application gallery 412 to a user for digital content item selection. In various cases, the contextual QR system 102 provides the client application gallery 412 by filtering digital content items of the client application according to the resolved filters of the context-aware QR code. For example, the contextual QR system 102 receives a filtered parameter indicating a specific physical location and filters digital content items of the client application to provide a client application gallery 412 of digital content items depicting that specific physical location (or that were generated in that location). In additional embodiments, the filtered parameter indicates other characteristics, such as events, content types, specific metadata tags, people, objects, etc., for identifying digital content associated with the indicated characteristics.

In one or more cases, the contextual QR system 102 further filters the digital content items of the client application gallery 412 by a context parameter indicating a maximum number of selectable digital content items, as discussed previously (as extracted from the digital design editing workflow). In various embodiments, the contextual QR system 102 provides a client application gallery 412 according to one or more resolved filters and only allows selection of a maximum number of content items of the client application gallery 412 (e.g., a number defined by the context of the digital design editing workflow). As further illustrated in FIG. 4, the contextual QR system 102 returns selected media 414 (digital content items) to the external device for uploading to the temporary storage location as defined by the QR code information.

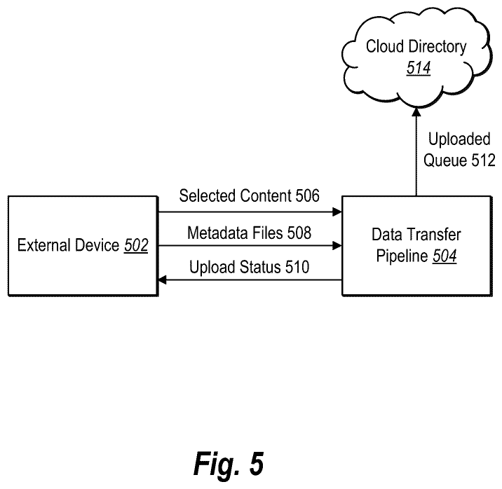

As noted above, in certain described embodiments, the contextual QR system 102 uploads selected digital content items to a temporary storage location for embedding within, or opening with, a digital design editing workflow. Specifically, in some cases, the contextual QR system 102 utilizes a data transfer pipeline to upload data associated with selected digital content items. FIG. 5 illustrates a diagram of the contextual QR system 102 transferring selected digital content items in accordance with one or more embodiments.

As illustrated in FIG. 5, the contextual QR system 102 transfers selected digital content items 506 from an external device 502 to a data transfer pipeline 504. Specifically, in some cases, the contextual QR system 102 provides selected digital content items 506 (as determined by contextual parameters) for uploading to a temporary storage location (e.g., a cloud directory 514). In addition to the selected digital content items 506, in some cases the contextual QR system 102 transfers metadata files 508 to the data transfer pipeline 504. In various cases, the contextual QR system 102 generates and passes a first metadata file indicating an initialization of an upload process of the selected digital content items to the data transfer pipeline 504. In these or other embodiments, the contextual QR system 102 also generates and passes a second metadata file indicating a termination of the upload process of the selected digital content items to the data transfer pipeline 504. In other embodiments, the contextual QR system 102 transfers the selected digital content items 506 via the indicated transfer protocol, such as via a download operation or a direct sharing operation.

In various cases, the contextual QR system 102 transfers (or pushes) each selected digital content item 506 and the associated metadata files 508 (e.g., initialization metadata file and/or termination metadata file) to the cloud directory 514 in an upload queue 512. In various embodiments, the contextual QR system 102 uploads the selected digital content items 506 one by one, beginning with the first selected digital content item. For example, the contextual QR system 102 organizes the upload queue 512 by uploading the initialization metadata file first to the cloud directory 514, indicating the start of the selected digital content item transfer, followed by the selected digital content items 506. In some embodiments, the contextual QR system 102 further organizes the upload queue 512 by uploading the termination metadata file after the final selected digital content item is transferred (e.g., uploaded) to the cloud directory 514. In one or more cases, the contextual QR system 102, upon transferring the termination metadata file to the cloud directory 514, sends a final upload status 510 to external device 502, indicating the completion of uploading the selected digital content items 506.

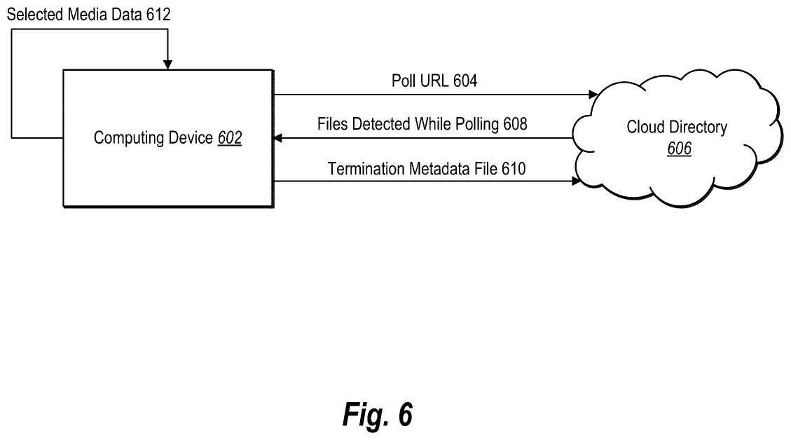

As mentioned above, in certain described embodiments, the contextual QR system 102 integrates selected digital content items into a digital design editing workflow. In addition, the contextual QR system 102 utilizes metadata files associated with the selected digital content items to determine when to integrate (or embed) data of the selected digital content items into the workflow. FIG. 6 illustrates a diagram of the contextual QR system 102 embedding digital content item data into a digital design editing workflow in accordance with one or more embodiments.

As illustrated in FIG. 6, the contextual QR system 102, as discussed previously, repeatedly polls the URL 604 of the cloud directory 606 after generating the cloud directory 606. In various cases, the contextual QR system 102 detects a file within the cloud directory 606 when polling the URL 604 and notifies the computing device 602 of the existence of files within the cloud directory 606. Specifically, in some embodiments, the contextual QR system 102, upon detecting the presence of data within the cloud directory 606, displays the progress of the upload process on the computing device 602 by passing the files detected while polling 608 to the computing device 602. For example, the contextual QR system 102 displays the progress of the upload on the computing device 602 based on the maximum digital content item parameter extracted from the digital design editing workflow.

As further shown in FIG. 6, in these or other embodiments, the contextual QR system 102, via the computing device 602, continues to poll the URL 604 until detecting the termination metadata file 610 (e.g., the second metadata file). In various cases, the contextual QR system 102 displays the upload progress on the computing device 602 until detecting the termination metadata file 610, upon which the contextual QR system 102 terminates polling the location indicated by URL 604. In various embodiments, the contextual QR system 102 provides a cancel call to action (“CTA”) user interface element on the computing device 602 that terminates the polling of the URL 604.

Upon termination of the polling (in response to detecting termination metadata file 610), in various cases, the contextual QR system 102 performs a desired action on the computing device 602 according to one or more contextual parameters of the digital design editing workflow. In some embodiments, the contextual QR system 102 embeds the selected media data 612 into the digital design editing workflow according to the contextual parameters of the workflow. For example, the contextual QR system 102 detects a content use parameter that instructs the contextual QR system 102 to embed selected digital content item data in predetermined locations of a graphical user interface within the digital design editing workflow.

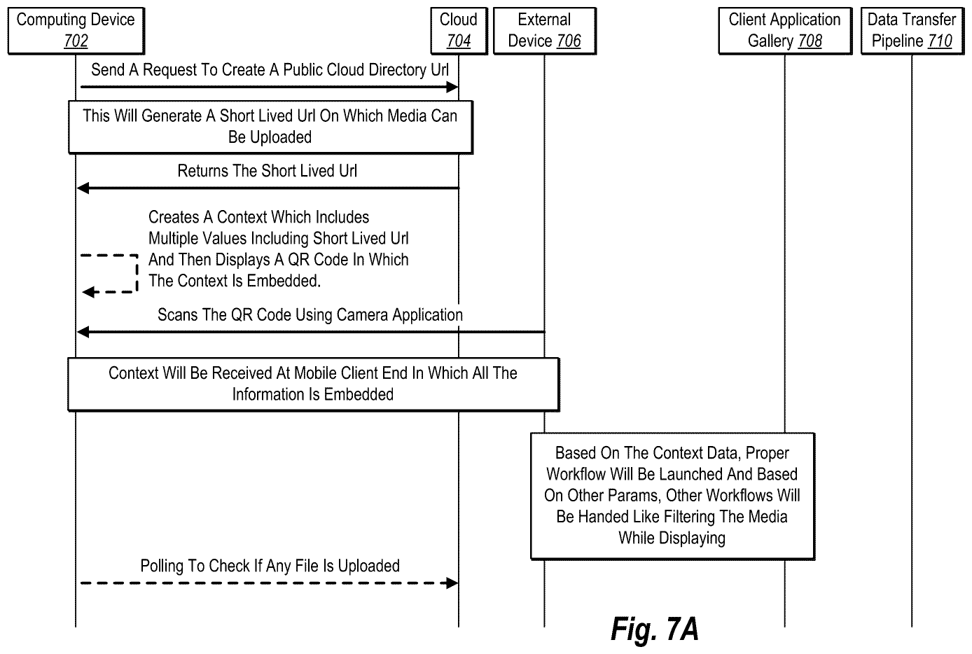

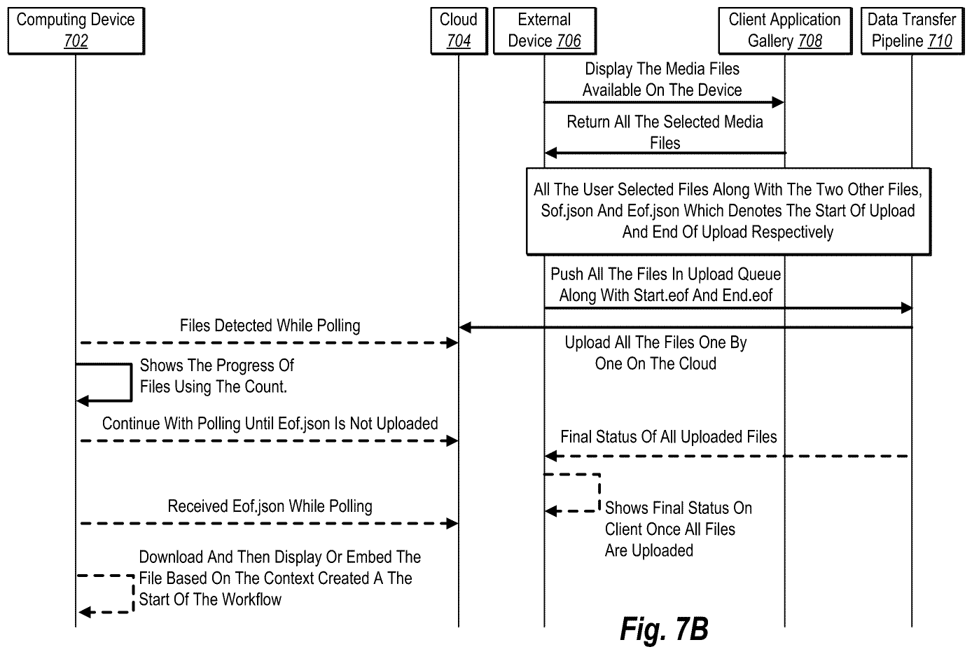

As mentioned above, in some cases, the contextual QR system 102 embeds digital content item data within a digital design editing workflow according to context parameters of the workflow. In particular, the contextual QR system 102 transfers digital content item data from an external device to a computing device for utilization within a digital design editing workflow. FIGS. 7A-7B illustrate a sequence diagram of the contextual QR system in accordance with one or more embodiments.

As shown in FIG. 7A, the contextual QR system 102 generates, in response to a user request to upload digital content to a computing device 702 from an external device 706, a public cloud directory URL. In some cases, the contextual QR system 102 generates a temporary public cloud directory (e. g, a cloud 704) with an associated unique URL. Upon generating the public cloud directory URL, in various embodiments, the contextual QR system 102 returns the short-lived URL (corresponding to the temporary public cloud directory) to the computing device 702. In various embodiments, the contextual QR system 102, via the computing device 702, repeatedly polls the short-lived URL to determine the availability of digital content items in the cloud 704.

Additionally, in some embodiments, the contextual QR system 102 extracts (or detects) one or more contextual parameters of a digital design editing workflow present on the computing device 702. For example, the contextual QR system 102 extracts one or more contextual parameters from a design application (e.g., performing the digital design editing workflow) running on the computing device 702, the contextual parameter(s) indicating one or more of a content use parameter, a content type parameter, or an application architecture parameter. From the extracted context parameters, in some cases, the contextual QR system 102 generates a unique contextID encompassing the context parameters and embeds the unique contextID into a QR code. In one or more embodiments, the contextual QR system 102 embeds the short-lived URL corresponding to the cloud 704 in conjunction with the unique contextID corresponding to the extracted context parameters into a context-aware QR code.

In various embodiments, the contextual QR system 102 utilizes an external device 706 to scan the context-aware QR code. In some cases, the contextual QR system 102 scans the context-aware QR code with a camera application of the external device 706. By scanning the context-aware QR code, in one or more embodiments, the contextual QR system 102 transfers the contextual parameters to the external device 706 by enabling access to the contextID as embedded within the context-aware QR code. Based on the contextual parameters encoded in the contextID, the contextual QR system 102, in some cases, launches a client application to access digital content items stored on the external device 706.

As shown in FIG. 7B, the contextual QR system 102 filters digital content items stored on a client application on the external device 706 according to contextual parameters of the digital design editing workflow, displaying a client application gallery 708 with content filtered according to the contextual parameters. In some cases, the contextual QR system 102 displays the filtered digital content items in the client application gallery 708 for further selection by a user. The contextual QR system 102 in various embodiments, returns the selected digital content items (e.g., media files) from the client application gallery 708 to the external device 706. From the external device 706, in some cases, the contextual QR system 102 transfers the selected digital content items and two metadata files to the data transfer pipeline 710. For example, the contextual QR system 102 transfers a first metadata file (e.g., a sof. json file) indicating the initialization of transferring the selected digital content items to the cloud 704 and a second metadata file (e.g., an eof. json file) indicating the termination of transferring the selected digital content items to the cloud 704.

In some embodiments, the contextual QR system 102 organizes each of the selected digital content items and the two metadata files in an upload queue within the data transfer pipeline 710. In particular, the contextual QR system 102, in various cases, starts the upload queue with the first metadata file, followed by the selected digital content items, and ends with the second metadata file. In various cases, the contextual QR system 102 displays the progress of the digital content items on the computing device 702 by utilizing a count stored within the metadata files. For example, the contextual QR system 102 generates the first metadata file and the second metadata file to include a media count indicating the number of selected digital image content items uploaded via the data transfer pipeline 710.

In some cases, the contextual QR system 102 polls the location indicated by the short-lived URL until it detects the second metadata file indicating the termination of uploading digital content items. Upon uploading the second metadata file, in various embodiments, the contextual QR system 102 informs the external device that the process of uploading the digital content items is complete. Similarly, in one or more embodiments, the contextual QR system 102 downloads the data of the one or more selected digital content items to the computing device 702 upon receiving the second metadata file (e.g., the eof. json file). In some cases, the contextual QR system 102 verifies the number of items retrieved based on the media count and embeds (and/or displays) the selected digital content items within the digital design editing workflow on the computing device 702, according to the contextual parameters of the workflow.

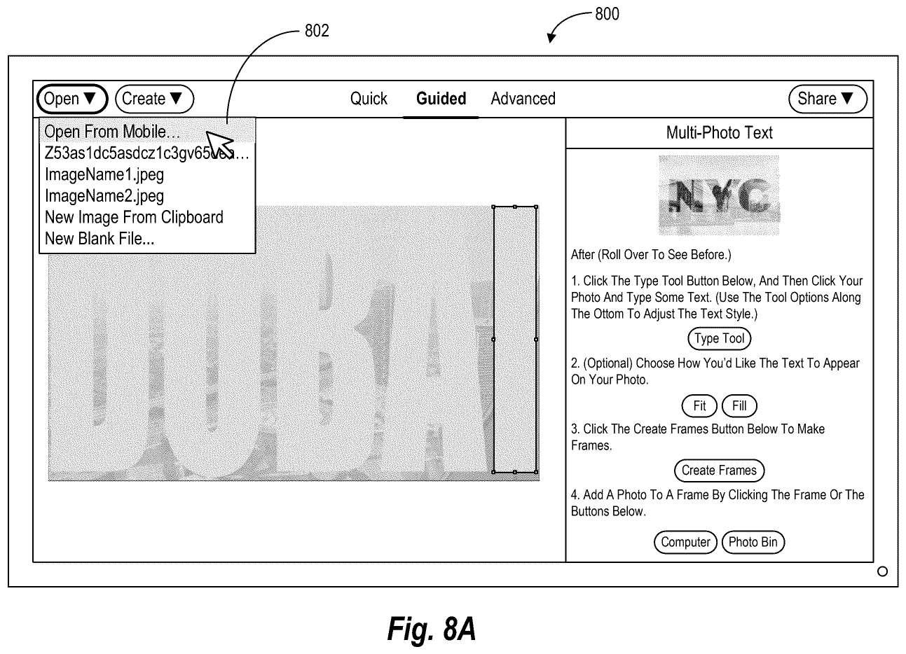

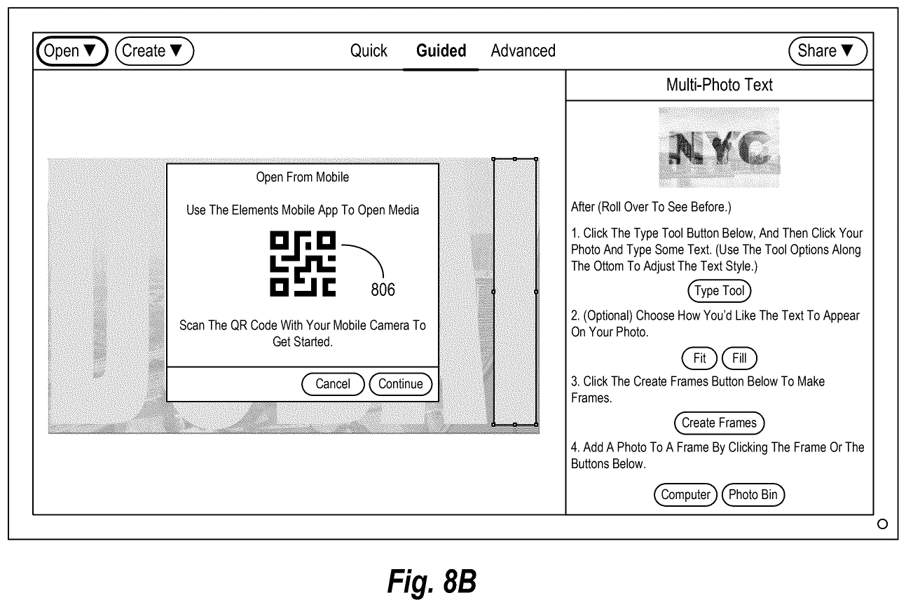

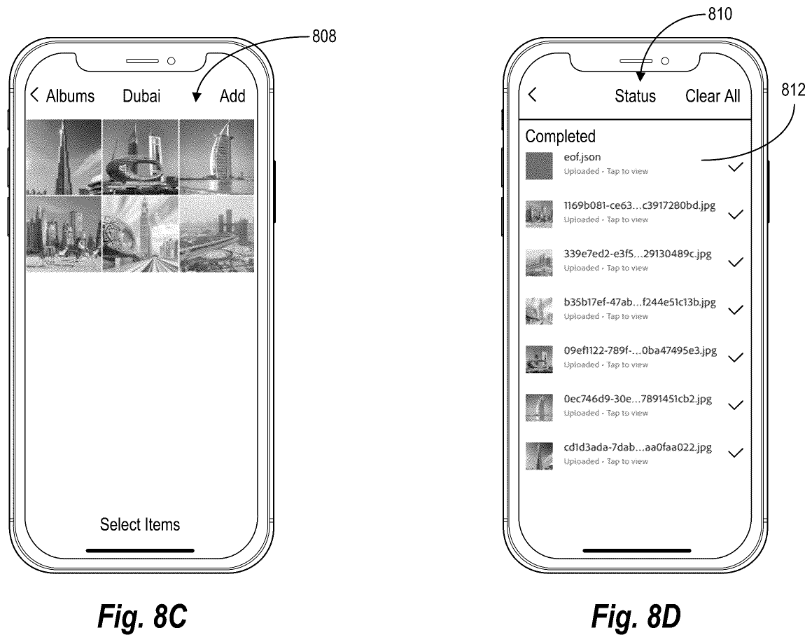

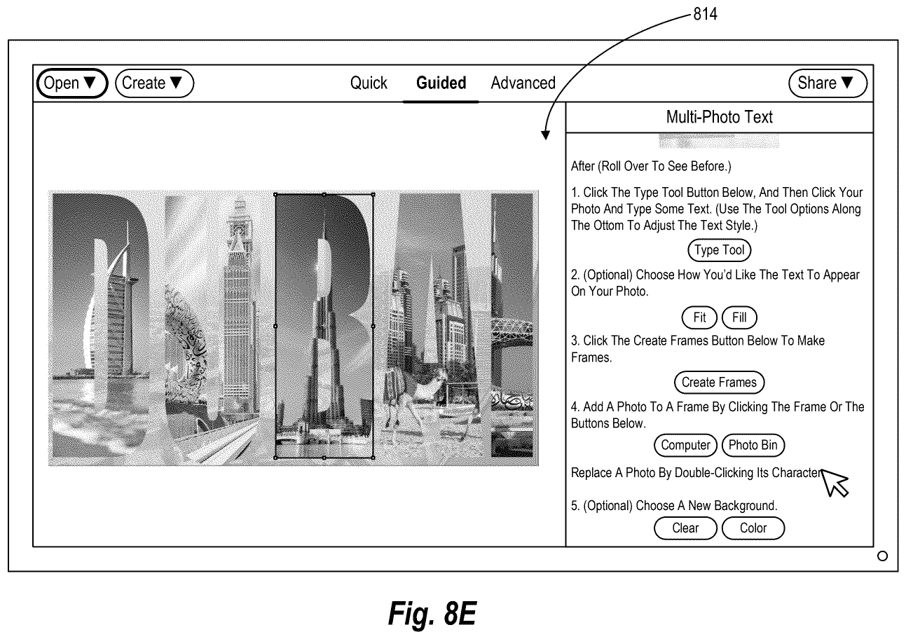

As noted above, in certain embodiments, the contextual QR system 102 embeds digital content item data from an external device in a digital design editing workflow. In particular, the contextual QR system 102 utilizes a graphical user interface to facilitate the incorporation of digital content items from an external device into a digital design editing workflow. FIGS. 8A-8E illustrate example graphical user interfaces for importing digital content into a digital design editing workflow using a context-aware QR in accordance with one or more embodiments.

Asillustrated in FIG. 8A, the contextual QR system 102 selects a user interface element 802 to request the retrieval of one or more digital content from an external device. In some embodiments, the contextual QR system 102 retrieves one or more digital content items from an external device according to one or more contextual parameters of the digital design editing workflow. For instance, the contextual QR system 102 detects a maximum number of digital content items to be placed within the graphical user interface 800 of a digital design editing workflow according to available locations for digital content items. For example, as shown in FIG. 8A, the contextual QR system 102 detects a maximum of six open locations for digital content items to be placed within the graphical user interface 800 of the digital design editing workflow (e.g., the five letters of “DUBAI” and the background image). In some embodiments, the contextual QR system 102 determines the number of locations for digital content items based on a number of separate selected elements, a number of elements in a particular layer, or based on a parameter indicating the number of digital content items.

As illustrated in FIG. 8B, the contextual QR system 102 generates a context-aware QR code 806 according to one or more extracted contextual parameters of the digital design editing workflow. In some cases, the contextual QR system 102 generates the context-aware QR code such that scanning the context-aware QR code with an external device accesses one or more digital content items stored on the external device. In particular, the contextual QR system 102, in various embodiments, generates the context-aware QR code to automatically provide digital content items to a user for selection based on one or more contextual parameters of the digital design editing workflow.

As shown in FIG. 8C, the contextual QR system 102 provides a client application gallery 808 to a user, where the digital content items stored within an application have been filtered according to one or more contextual parameters. For example, the contextual QR system 102 filtered the digital content items of a photo application according to the location filter “Dubai” as extracted from the digital design editing workflow, as discussed in relation to FIG. 8A.

As illustrated in FIG. 8D, the contextual QR system 102, in some cases, uploads the selected digital content items to a temporary storage location (e.g., a cloud). In particular, in some cases, the contextual QR system 102 returns a status update 810 to the external device indicating the status of uploading the selected digital content items. In addition, in these or other embodiments, the contextual QR system 102 informs the user of the completeness of the upload process by providing the status of the second metadata file (e.g., eof.json 812) indicating the termination of the upload process.

As shown in FIG. 8E, the contextual QR system 102 downloads the data of the uploaded selected digital content items on the computing device and embeds the data into the graphical user interface 814 digital design editing workflow. Specifically, the contextual QR system 102, in some cases, embeds the data of the selected digital content items according to the previously determined contextual parameters of the digital design editing workflow. For example, as the contextual QR system 102 previously determined that there were six locations for embedding digital content item data, the contextual QR system 102 embeds the six selected digital content items in those previously determined locations of the graphical user interface 814. In alternative embodiments, the contextual QR system 102 performs operations to open each of the digital content items as a separate image, a separate project, or as a separate layer in connection with the digital design editing workflow. Additionally, in some embodiments, the contextual QR system 102 provides tools for editing the inserted or opened digital content items in connection with the digital design editing workflow.

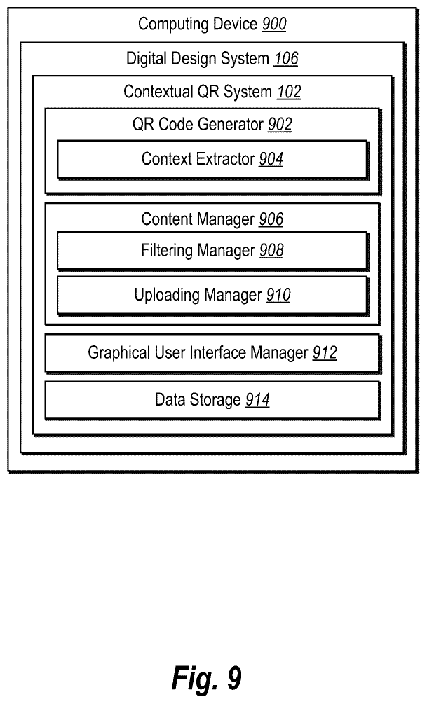

Looking now to FIG. 9, additional detail will be provided regarding components and capabilities of the contextual QR system 102. Specifically, FIG. 9 illustrates an example schematic diagram of the contextual QR system 102 on an example computing device 900 (e.g., one or more of the client device 110 and/or the server device(s) 104). In some embodiments, the computing device 900 refers to a distributed computing system where different managers are located on different devices, as described above. As shown in FIG. 9, the contextual QR system 102 includes a QR code generator 902 including a context extractor 904, a content manager 906 including a filtering manager 908 and an uploading manager 910, a graphical user interface manager 912, and data storage 914.

As just mentioned, the contextual QR system 102 includes a QR code generator 902. In particular, the QR code generator 902 creates, determines, or generates a context-aware QR code based on a digital design editing workflow. In some cases, the QR code generator 902 embeds relevant contextual parameters (e.g., metadata) of a digital design editing workflow into a QR code in response to a request to upload a digital content item from an external device. For instance, the QR code generator 902 generates a context-aware QR code including one or more relevant contextual parameters and/or a location of a temporary storage location for uploading a digital content item from an external device for use within the digital design editing workflow.

As shown, the QR code generator 902 also includes a context extractor 904 based on a digital design editing workflow. In particular, the context extractor 904 operates in conjunction with, or includes, the QR code generator 902. For example, the QR code generator 902 extracts (or determines) one or more contextual parameters from a digital design editing workflow including one or more of content use parameters, content type parameters, or application architecture parameters. In some embodiments, the QR code generator 902 facilitates the selection of one or more contextual parameters by a user within a graphical user interface in generating a context-aware QR code.

As further shown in FIG. 9, the contextual QR system 102 also includes a content manager 906 that manages, maintains, determines, identifies, or generates digital images via an image generation neural network. For example, the content manager 906, by passing the contextual parameters of the digital design editing workflow to an external device, facilitates the uploading of digital content items from an external device to a temporary storage location as determined by a context-aware QR code.

As illustrated in FIG. 9, the content manager 906 also includes a filtering manager 908. In particular, the filtering manager 908 manages, determines, generates, or facilitates the filtering of digital content items on an external device (e.g., external application) for selection according to contextual parameters of a digital design editing workflow. For example, the filtering manager 908 decodes one or more contextual parameters embedded in a context-aware QR code and passes the contextual parameters to an external device, thus filtering digital content items on the external device according to the one or more contextual parameters. Additionally, the filtering manager 908, by passing the contextual parameters to the external device, provide a set of filtered content items (according to the contextual parameters) to a user for selection.

As also shown in FIG. 9, the content manager 906 also includes an uploading manager 910. In particular, the uploading manager manages, determines, or facilitates the uploading of one or more digital content items from an external device to a temporary storage location. For example, the uploading manager 910 passes digital content item data, upon selection by a user from a filtered set of content items, to a temporary storage location as defined by a context-aware QR code. Furthermore, in various embodiments, the uploading manager 910 passes a first metadata file indicating the start of the digital content item uploading process and a second metadata file indicating the end of the uploading process to the temporary storage location.

As further illustrated in FIG. 9, the contextual QR system 102 includes graphical user interface manager 912. In particular, the graphical user interface manager 912 manages, maintains, generates, determines, or identifies user interactions with a graphical user interface. For example, the graphical user interface manager 912 manages the embedding of digital content item data into the digital design editing workflow as determined by one or more contextual parameters. In some cases, the graphical user interface manager 912 communicates with the other components of the contextual QR system 102 to facilitate the operations and functions described herein.

As shown in FIG. 9, the contextual QR system 102 also includes a data storage 914. The data storage 914 operates in conjunction with, or includes, the QR code generator 902, the content manager 906, and/or the graphical user interface manager 912. In some cases, the data storage 914 manages the storage of data of one or more digital content items selected on an external device according to one or more contextual parameters. In various embodiments, the data storage 914 makes digital content item data available for embedding within a graphical user interface. In one or more cases, the data storage 914 communicates with the other components of the contextual QR system 102 to facilitate the operations and functions described herein.

In one or more embodiments, each of the components of the contextual QR system 102 are in communication with one another using any suitable communication technologies. Additionally, the components of the contextual QR system 102 are in communication with one or more other devices including one or more client devices described above. It will be recognized that although the components of the contextual QR system 102 are shown to be separate in FIG. 9, any of the subcomponents may be combined into fewer components, such as into a single component, or divided into more components as may serve a particular implementation. Furthermore, although the components of FIG. 9 are described in connection with the contextual QR system 102, at least some of the components for performing operations in conjunction with the contextual QR system 102 described herein may be implemented on other devices within the environment.

The components of the contextual QR system 102, in one or more implementations, includes software, hardware, or both. For example, the components of the contextual QR system 102 include one or more instructions stored on a computer-readable storage medium and executable by processors of one or more computing devices. When executed by the one or more processors, the computer-executable instructions of the contextual QR system 102 cause the computing device 900 to perform the methods described herein. Alternatively, the components of the contextual QR system 102 comprises hardware, such as a special purpose processing device to perform a certain function or group of functions. Additionally, or alternatively, the components of the contextual QR system 102 includes a combination of computer-executable instructions and hardware.

Furthermore, the components of the contextual QR system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the contextual QR system 102 may be implemented as part of a stand-alone application on a personal computing device or a mobile device. Alternatively, or additionally, the components of the contextual QR system 102 may be implemented in any application that allows creation and delivery of marketing content to users, including, but not limited to, applications in ADOBE ® CREATIVE CLOUD ®, such as ADOBE ® ACROBAT ®, DOCUMENT CLOUD ®, and EXPRESS®. “ADOBE,” “CREATIVE CLOUD,” “ACROBAT,” “DOCUMENT CLOUD,” and “EXPRESS” are either registered trademarks or trademarks of Adobe Inc. in the United States and/or other countries.

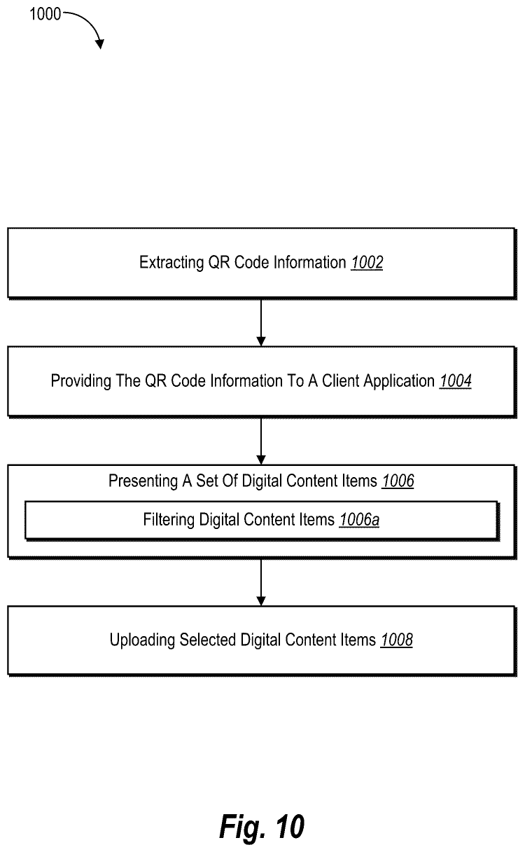

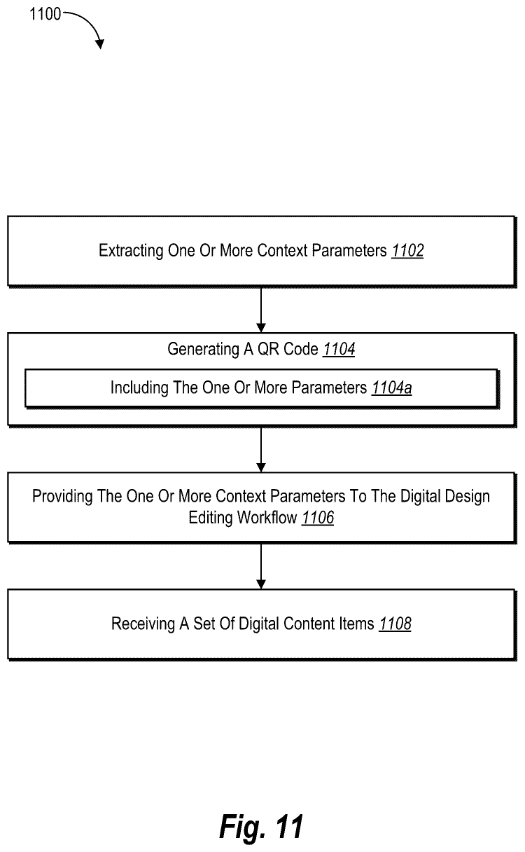

FIGS. 1-9, the corresponding text, and the examples provide a number of different systems, methods, and non-transitory computer readable media for embedding data of digital content items within a digital design editing workflow via a context-aware QR code. In addition to the foregoing, embodiments are describable in terms of flowcharts comprising acts for accomplishing a particular result. For example, FIGS. 10-11 illustrate flowcharts of example sequences or series of acts in accordance with one or more embodiments.

While FIGS. 10-11 illustrate acts according to particular embodiments, alternative embodiments may omit, add to, reorder, and/or modify any of the acts shown in FIGS. 10-11. The acts of FIGS. 10-11 are sometimes performed as part of a method. Alternatively, a non-transitory computer readable medium comprises instructions, that when executed by one or more processors, cause a computing device to perform the acts of FIGS. 10-11. In still further embodiments, a system performs the acts of FIGS. 10-11. Additionally, the acts described herein may be repeated or performed in parallel with one another or in parallel with different instances of the same or other similar acts.

FIG. 10 illustrates a flowchart of a series of acts 1000 for uploading selected digital content items by extracting QR code information including context parameters in accordance with one or more embodiments. In particular, the series of acts 1000 includes an act 1000 of extracting QR code information. For example, the act 1002 involves extracting, by one or more processors of a first device in response to scanning a QR code, QR code information including one or more context parameters of a digital design editing workflow at a second device as defined by a unique context identifier within the QR code.

In addition, the series of acts 1000 includes an act 1004 of providing the QR code information to a client application. For example, the act 1000 involves providing, by the one or more processors, the QR code information including the one or more context parameters of the digital design editing workflow to a client application of the first device.

As further illustrated in FIG. 10, the series of acts 1000 includes an act 1006 of presenting a set of digital content items. In particular, the act 1006 involves presenting, by the one or more processors, a set of digital content items within the client application of the first device by filtering digital content items stored on the first device according to the one or more context parameters of the digital design editing workflow. In some cases, the act 1006 includes an act 1006a of filtering digital content items.

As also shown in FIG. 10, the series of acts 1000 includes an act 1008 of uploading selected digital content items. Specifically, the act 1008 includes involves uploading, by the one or more processors of the first device, selected digital content items from the set of digital content items to a temporary storage location corresponding to the QR code.

In one or more embodiments, the series of acts 1000 includes an act of presenting by determining a media count indicating a maximum number of selected digital content items from the set of digital content items. In addition, the series of acts 1000 includes an act of restricting a number of digital content items selected for uploading to the temporary storage location according to the media count.

In certain embodiments, the series of acts 1000 includes an act of uploading selected digital content items by generating a first metadata file indicating an initialization of an upload of the selected digital content items and a second metadata file indicating a termination of the upload of the selected digital content items. Additionally, the series of acts 1000 includes an act of uploading the selected digital content items with the first metadata file and the second metadata file to the temporary storage location.

In some cases, the series of acts 1000 includes an act of providing the QR code information including the one or more context parameters of the digital design editing workflow by launching a client application of the first device according to one or more context parameters of the digital design editing workflow. Further, the series of acts 1000 includes an act of providing the QR code information including the one or more context parameters of the digital design editing workflow to the client application of the first device.

In one or more cases, the series of acts 1000 includes an act of presenting the set of digital content items within the client application of the first device by filtering digital content items stored on the first device according to one or more contextual parameters indicating one or more of a geographical location, a person identifier, or a content tag based on the digital design editing workflow.

In some embodiments, the series of acts 1000 includes an act of detecting a request to select one or more additional digital content items stored on the first device and not displayed with the set of digital content items. Additionally, the series of acts 1000 includes an act of receiving no selection of digital content items of the set of digital content items. Furthermore, the series of acts 1000 includes an act of providing the digital content items stored on the first device without filtering. Moreover, the series of acts involves an act of uploading the one or more additional digital content items stored on the first device to the temporary storage location corresponding to the QR code.

In one or more cases, the series of acts 1000 includes extracting, by one or more processors of a first device in response to scanning a QR code, QR code information including one or more context parameters of a digital design editing workflow at a second device as defined by a unique context identifier within the QR code. The series of acts 1000 also includes providing, by the one or more processors, the QR code information including the one or more context parameters of the digital design editing workflow to a client application of the first device. The series of acts 1000 further includes presenting, by the one or more processors, a set of digital content items within the client application of the first device by filtering digital content stored on the first device according to the one or more context parameters of the digital design editing workflow. The series of acts additionally includes uploading, by the one or more processors of the first device, selected digital content items from the set of digital content items to a temporary storage location corresponding to the QR code.

In various cases, the series of acts 1000 includes an act of extracting QR code information including one or more context parameters by extracting, from the QR code, one or more content use parameters indicating one or more of a geographical location, a person identifier, or a content tag based on the digital design editing workflow.

In some embodiments, the series of acts 1000 includes an act of extracting QR code information including one or more context parameters by extracting, from the QR code, one or more content type parameters indicating a file type of digital content items to be used within the digital design editing workflow.

In one or more embodiments, the series of acts 1000 includes an act of extracting the QR code information including one or more context parameters by determining, from the QR code, a media count indicating a maximum number of digital content items to be inserted into a digital design as part of the digital design editing workflow. Additionally, the series of acts 1000 includes an act of limiting a number of the selected digital content items in the client application to the maximum number of digital content items indicated by the media count.

In some cases, the series of acts 1000 includes an act of uploading selected digital content items by generating a first metadata file indicating an initialization of an upload of the selected digital content items and a second metadata file indicating a termination of the upload of the selected digital content items. Additionally, the series of acts 1000 includes an act of uploading the selected digital content items with the first metadata file and the second metadata file to the temporary storage location.

FIG. 11 illustrates a flowchart of a series of acts for receiving a set of digital content items by generating a QR code including context parameters in accordance with one or more embodiments. In particular, the series of acts 1100 includes an act 1102 of extracting one or more context parameters. For example, act 1102 involves extracting, in response to a request to retrieve digital content from an external device, one or more context parameters corresponding to a digital design editing workflow of a client application.

As shown, the series of acts 1100 includes an act 1104 of generating a QR code. For example, act 1104 involves generating a QR code including the one or more context parameters with a unique context identifier that maps the QR code to the digital design editing workflow. In some cases, the act 1104 includes an act 1104a of including the one or more context parameters.

As also shown in FIG. 11, the series of acts 1100 includes an act 1106 of providing the one or more context parameters to the digital design editing workflow. For example, the act 1106 involves providing the one or more context parameters and the unique context identifier to the external device in response to an execution of the QR code on the external device to cause the external device to search for digital content items corresponding to the one or more context parameters.

In addition, the series of acts 1100 includes an act 1108 of receiving a set of digital content items. For example, the act 1108 involves receiving, via a data transfer protocol corresponding to the QR code, a set of digital content items selected from the digital content items corresponding to the one or more context parameters at the external device.

Furthermore, the series of acts 1100 includes an act of extracting the one or more context parameters by extracting one or more user-selected parameters determined via user input within a graphical user interface, the one or more user-selected parameters indicating utilization of digital content items within the digital design editing workflow.

In one or more embodiments, the series of acts 1100 includes an act of extracting the one or more context parameters corresponding to a digital design editing workflow of a client application by extracting contextual information according to content elements of the digital design editing workflow including one or more of text, images, graphics, or multimedia assets present in the digital design editing workflow.

In various cases, the series of acts 1100 includes an act of inserting the set of digital content items selected from the digital content items into one or more locations of a digital design displayed in the client application based on a context parameter of the one or more context parameters indicating insertion of the set of digital content items into the digital design.

In some embodiments, the series of acts 1100 includes an act of receiving the set of digital content items selected from the digital content items by detecting one or more digital content items of the set of digital content items within a temporary storage location associated with the QR code. Additionally, the series of acts 1100 includes an act of performing an operation on the one or more digital content items in the client application according to the one or more context parameters corresponding to the digital design editing workflow.

In one or more cases, the series of acts 1100 includes an act of extracting the one or more context parameters by determining a media count indicating a maximum number of selected digital content items to obtain from the external device based on a number of corresponding digital assets in a digital design of the digital design editing workflow or based on a selected media count parameter of the client application.

In some embodiments, the series of acts 1100 includes an act of determining the media count indicating the maximum number of selected digital content items by receiving, with the set of digital content items, a first metadata file indicating a start of the set of digital content items and a second metadata file indicating an end of the set of digital content items. Additionally, the series of acts 1100 includes an act of determining the media count based on the start of the set of digital content items indicated by the first metadata file and the end of the set of digital content items indicated by the second metadata file.

In one or more cases, the series of acts 1100 includes an act of extracting one or more context parameters corresponding to a digital design editing workflow of a client application by extracting one or more of a content use parameter indicating an interaction with a digital content item within the digital design editing workflow, a content type parameter indicating a nature of a digital content item to be utilized within the digital design editing workflow, or an application architecture parameter indicating attributes of the client application relative to a digital design editing workflow.

In various embodiments, the series of acts 1100 includes an act of generating the QR code by generating a unique URL for a public cloud directory that stores digital content items corresponding to the digital design editing workflow. Additionally, the series of acts 1100 includes an act of generating encoded context parameters by encoding the one or more context parameters. Furthermore, the series of acts 1100 includes an act of generating the QR code including the encoded context parameters and the unique URL.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 12 illustrates, in block diagram form, an example computing device 1200 (e.g., the computing device 1200, the client device 110, and/or the server device(s) 104) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

1. A computer-implemented method comprising:
extracting, by one or more processors of a first computing device in response to scanning a scannable code via the first computing device, scannable code information including:
a unique context identifier associated with a digital design editing workflow performed at a second computing device external to the first computing device; and
context parameters of the digital design editing workflow identified as defined by the unique context identifier, wherein the context parameters of the digital design editing workflow comprise:
a content use parameter indicating an interaction of a digital content item within the digital design editing workflow; and
a content type parameter indicating a nature of the digital content item to be utilized within the digital design editing workflow;
providing, by the one or more processors, the scannable code information including the context parameters of the digital design editing workflow to a client application of the first computing device;
presenting, by the one or more processors, a subset of digital content items within the client application of the first computing device by automatically filtering a set of digital content items stored on the first computing device according to the context parameters extracted from the scannable code corresponding to the digital design editing workflow, the subset of digital content items including the digital content item; and
uploading, by the one or more processors of the first computing device, selected digital content items from the set of digital content items, including the digital content item, to a temporary storage location corresponding to the scannable code.

2. The computer-implemented method of claim 1, wherein presenting comprises:
determining a media count indicating a maximum number of selected digital content items from the set of digital content items; and
restricting a number of digital content items selected for uploading to the temporary storage location according to the media count.

3. The computer-implemented method of claim 1, wherein uploading the selected digital content items comprises:
generating a first metadata file indicating an initialization of an upload of the selected digital content items and a second metadata file indicating a termination of the upload of the selected digital content items; and
uploading the selected digital content items with the first metadata file and the second metadata file to the temporary storage location.

4. The computer-implemented method of claim 1, wherein providing the scannable code information including the one or more context parameters of the digital design editing workflow comprises:
launching the client application of the first computing device according to the context parameters of the digital design editing workflow; and
providing the scannable code information including the context parameters of the digital design editing workflow to the client application of the first computing device.

5. The computer-implemented method of claim 1, wherein presenting the set of digital content items within the client application of the first computing device comprises filtering digital content items stored on the first computing device according to the content type parameter indicating one or more of a geographical location, a person identifier, or a content tag based on the digital design editing workflow.

6. The computer-implemented method of claim 1, further comprising:
detecting a request to select one or more additional digital content items stored on the first computing device and not displayed with the set of digital content items;
receiving no selection of digital content items of the set of digital content items;
providing the digital content items stored on the first computing device without filtering; and
uploading the one or more additional digital content items stored on the first computing device to the temporary storage location corresponding to the scannable code.

7. A system comprising:
one or more memory devices; and
one or more processors coupled to the one or more memory devices that cause the system to perform operations comprising:
extracting, in response to a request to retrieve digital content from an external computing device, context parameters corresponding to a digital design editing workflow performed at a client application of a second computing device, the context parameters comprising:
a content use parameter indicating an interaction of a digital content item within the digital design editing workflow; and
a content type parameter indicating a nature of the digital content item to be utilized within the digital design editing workflow;
generating a scannable code including the one or more context parameters with a unique context identifier that maps the scannable code to the digital design editing workflow of the second computing device;
providing the context parameters and the unique context identifier to the external computing device in response to an execution of the scannable code on the external computing device to cause the external computing device to search for digital content items, including the digital content item, corresponding to the context parameters extracted from the scannable code; and
receiving, via a data transfer protocol corresponding to the scannable code, a set of digital content items including the digital content item selected from the digital content items corresponding to the context parameters at the external computing device.

8. The system of claim 7, wherein extracting the context parameters comprises extracting one or more user-selected parameters determined via user input within a graphical user interface, the one or more user-selected parameters indicating utilization of digital content items within the digital design editing workflow.

9. The system of claim 7, wherein extracting the context parameters corresponding to the digital design editing workflow of the client application comprises extracting contextual information according to content elements of the digital design editing workflow including one or more of text, images, graphics, or multimedia assets present in the digital design editing workflow.

10. The system of claim 7, further comprising inserting the set of digital content items selected from the digital content items into one or more locations of a digital design displayed in the client application based on a context parameter of the context parameters indicating insertion of the set of digital content items into the digital design.

11. The system of claim 7, wherein receiving the set of digital content items selected from the digital content items comprises:
detecting digital content items of the set of digital content items within a temporary storage location associated with the scannable code; and
performing an operation on the digital content items in the client application according to the context parameters corresponding to the digital design editing workflow.

12. The system of claim 7, wherein extracting the one or more context parameters comprises determining a media count indicating a maximum number of selected digital content items to obtain from the external computing device based on a number of corresponding digital assets in a digital design of the digital design editing workflow or based on a selected media count parameter of the client application.

13. The system of claim 12, wherein determining the media count indicating the maximum number of selected digital content items comprises:
receiving, with the set of digital content items, a first metadata file indicating a start of the set of digital content items and a second metadata file indicating an end of the set of digital content items; and
determining the media count based on the start of the set of digital content items indicated by the first metadata file and the end of the set of digital content items indicated by the second metadata file.

14. The system of claim 7, wherein extracting the one or more context parameters corresponding to the digital design editing workflow of the client application comprises extracting the content use parameter indicating the interaction with the digital content item within the digital design editing workflow, the content type parameter indicating a nature of the digital content item to be utilized within the digital design editing workflow, and an application architecture parameter indicating attributes of the client application relative to the digital design editing workflow.

15. The system of claim 7, wherein generating the scannable code comprises:
generating a unique URL for a public cloud directory that stores digital content items corresponding to the digital design editing workflow;
generating encoded context parameters by encoding the context parameters; and
generating the scannable code including the encoded context parameters and the unique URL.

16. A non-transitory computer-readable medium storing instructions thereon that, when executed by at least one processor, cause the at least one processor to perform operations comprising:
extracting, by processors of a first computing device in response to scanning a scannable code via the first computing device, scannable code information including:
a unique context identifier associated with digital design editing workflow performed at a second computing device external to the first computing device; and
context parameters of the digital design editing workflow identified by the unique context identifier, wherein the context parameters of the digital design editing workflow comprise:
a content use parameter indicating an interaction of a digital content item within the digital design editing workflow; and
a content type parameter indicating a nature of the digital content item to be utilized within the digital design editing workflow;
providing, by the processors, the scannable code information including the context parameters of the digital design editing workflow to a client application of the first computing device;
presenting, by the processors, a subset of digital content items within the client application of the first computing device by automatically filtering a set of digital content stored on the first computing device according to the context parameters extracted from the scannable code corresponding to the digital design editing workflow, the subset of digital content items including the digital content item; and
uploading, by the processors of the first computing device, selected digital content items from the subset of digital content items, including the digital content item, to a temporary storage location corresponding to the scannable code.

17. The non-transitory computer-readable medium of claim 16, wherein extracting the scannable code information including the context parameters comprises extracting, from the scannable code, content use parameters indicating one or more of a geographical location, a person identifier, or a content tag based on the digital design editing workflow.

18. The non-transitory computer-readable medium of claim 16, wherein extracting the scannable code information including the context parameters comprises extracting, from the scannable code, content type parameters indicating a file type of digital content items to be used within the digital design editing workflow.

19. The non-transitory computer-readable medium of claim 16, wherein:
extracting the scannable code information including the context parameters comprises determining, from the scannable code, a media count indicating a maximum number of digital content items to be inserted into a digital design as part of the digital design editing workflow; and
limiting a number of the selected digital content items in the client application to the maximum number of digital content items indicated by the media count.

20. The non-transitory computer-readable medium of claim 16, wherein uploading the selected digital content items comprises:
generating a first metadata file indicating an initialization of an upload of the selected digital content items and a second metadata file indicating a termination of the upload of the selected digital content items; and
uploading the selected digital content items with the first metadata file and the second metadata file to the temporary storage location.
